(19) United States
(12) Patent Application Publication
(10) Pub. No.: US 2004/0078558 A1
(43) Pub. Date: Apr. 22, 2004

(54) Method and apparatus to process instructions in a processor

(76) Inventor: Eric A. Sprangle, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/105,686

(22) Filed: Mar. 25, 2002

(51) Int. Cl. G06F 9/00

(52) U.S. Cl. 712/229

(57) ABSTRACT

A method and apparatus for processing an instruction in a processor comprising operating the processor in a particular mode of operation, determining whether sources the instruction depended upon are valid, and flushing an instruction pipeline depending on the mode of operation of the processor. In the normal mode of the processor's pipeline is flushed when a miss-prediction is detected. In the cautious mode the processor's pipeline is flushed only when a late checker determines that sources the instruction depended upon are invalid and a miss-prediction has been determined by the execution unit more than once.

### BACKGROUND OF THE INVENTION

1. Field of the Invention

The present invention is related to the field of electronics. In particular, the present invention is related to a method and apparatus to execute instructions in a processor.

2. Description of the Related Art

Out-of-order processors commonly use a pipelining technique wherein multiple instructions are overlapped in execution in an effort to improve the overall performance of the processor e.g., a microprocessor. This allows for a processor to execute a program faster with a lower total execution time, even though no single instruction runs faster.

In a pipelined processor, the latency from scheduling an instruction to executing the instruction, and then confirming the instruction executed correctly may be significantly longer than the latency of the instruction. Therefore, to minimize the effective latency of the instruction, dependent instructions are scheduled before confirming that the first instruction executed correctly. In a pipelined processor, a scheduler speculatively schedules instructions assuming that all instructions will execute properly (e.g., all load instructions will hit in data cache). Thus, a situation may arise that prevents an instruction from executing correctly during its designated clock cycle if the instruction requires the results of the previous instruction in order for it to execute correctly.

In out-of-order branch speculative execution wherein the processor routinely uses an internal branch prediction algorithm to calculate the result of branches in the program code and speculatively executes instructions down a pre-determined code branch, miss-prediction of a branch causes the instructions following the branch in the pipeline to be flushed and restarts the instruction execution down the correct program branch. Although branch prediction algorithms are highly accurate, they are not 100 percent infallible. On pipelines designed with greater depth, more instructions must be flushed from the pipeline, resulting in a longer recovery time from a branch miss-predict. The net result is that applications that contain several difficult-to-predict branches tend to have a lower than average instructions executed per clock cycle (IPC).

FIG. 1 illustrates a flow diagram of a branch instruction executed in a processor according to a prior art embodiment. FIG. 1 illustrates the normal mode of operation of the processor. At 105 a branch prediction algorithm predicts the address of a branch instruction. After the branch prediction algorithm predicts the address of the branch instruction the scheduler schedules the branch instruction for execution by the execution unit. At 110, an early checker determines whether the sources of the branch instruction are correct. The early checker makes this determination based on some of the information available to it. This means e.g., if a branch instruction is dependent on a load instruction, then the early checker determines whether the result of the load instruction (i.e., the sources), was available to the branch instruction before the branch instruction executed. If the early checker determines that the sources are correct (i.e., the sources were available before the branch instruction executes) an “early safe” flag is set to 1 at 114. Else, if the early checker determines that the sources are not correct the “early safe” flag is set to 0 at 112.

Thereafter, the execution unit determines whether the calculated branch address is equal to the predicted branch address at 120. If the execution unit determines that the calculated branch address is not equal to the predicted branch address (i.e., the branch is miss-predicted) then, at 115, a determination is made (e.g., by the scheduler or by a controller) whether the early safe flag is set to a 1. If the early safe flag is set to a 1, at 116 the instruction pipeline of the out-of-order processor is flushed. At 115, if the early safe flag is set to a 0, or if the instruction pipeline has been flushed, or if the calculated address is equal to the predicted address, at 130, the late checker determines if the sources are correct, and if so, the process ends at 126. However, if the late checker determines that the sources are not correct, at 135, the process described above re-executes.

Since the early checker does not comprehend all of the reasons that a source may be incorrect, it is possible to trigger a branch recovery (i.e., re-execute a branch instruction) for a branch that was correctly predicted. For example, assuming the branch prediction algorithm correctly predicts a branch, it is possible for the early checker to incorrectly set the early safe flag to a ‘1’. This is possible because the early checker does not have all the information needed to make this decision. Based on the early checker incorrectly determining the sources to be valid, the execution unit erroneously determines the branch is miss-predicted, (i.e., the execution unit determines that the calculated branch address is not equal to the predicted branch address), and the instruction pipeline is erroneously flushed at 116. At 130, the late checker determines that the sources are not valid (which the early checker should have determined at 110), and re-executes the branch instruction. Thus, the instruction pipeline is erroneously flushed at 116, thereby reducing the efficiency of the out-of-order processor.

### BRIEF SUMMARY OF THE DRAWINGS

Examples of the present invention are illustrated in the accompanying drawings. The accompanying drawings, however, do not limit the scope of the present invention. Similar references in the drawings indicate similar elements.

FIG. 1 illustrates a flow diagram of a branch instruction executed in a processor according to a prior art embodiment;

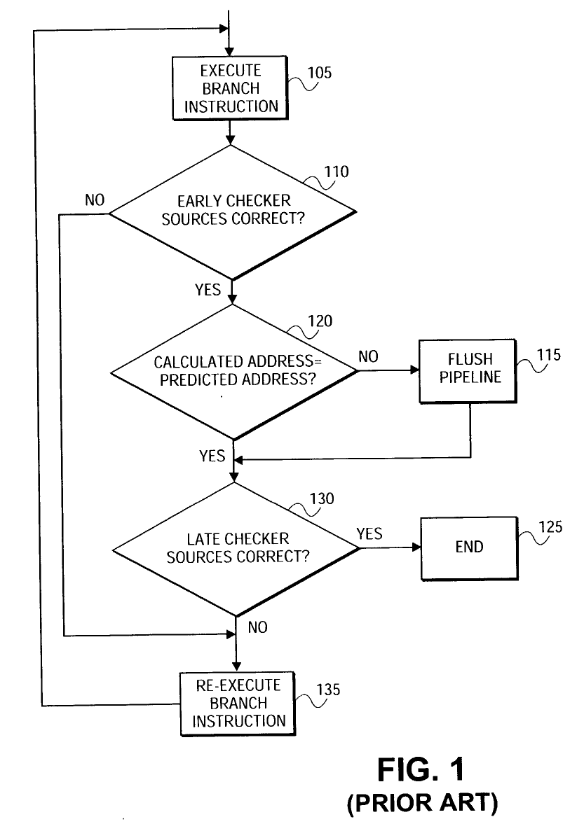

FIG. 2 illustrates a flow diagram of a branch instruction executed in a processor according to one embodiment of the invention;

FIG. 3 illustrates a processor according to one embodiment of the invention;

FIG. 4 illustrates a flow diagram illustrating when a processor switches modes according to one embodiment of the invention;

FIG. 5 illustrates a flow diagram of a branch instruction executed in a processor according to another embodiment of the invention

### DETAILED DESCRIPTION OF THE INVENTION

Described is a method and apparatus to process instructions in a processor using a validity bit, an early checker and a late checker. In the following description, numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid unnecessarily obscuring the present invention.

Parts of the description is presented using terminology commonly employed by those skilled in the art to convey the substance of their work to others skilled in the art. Also, parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components.

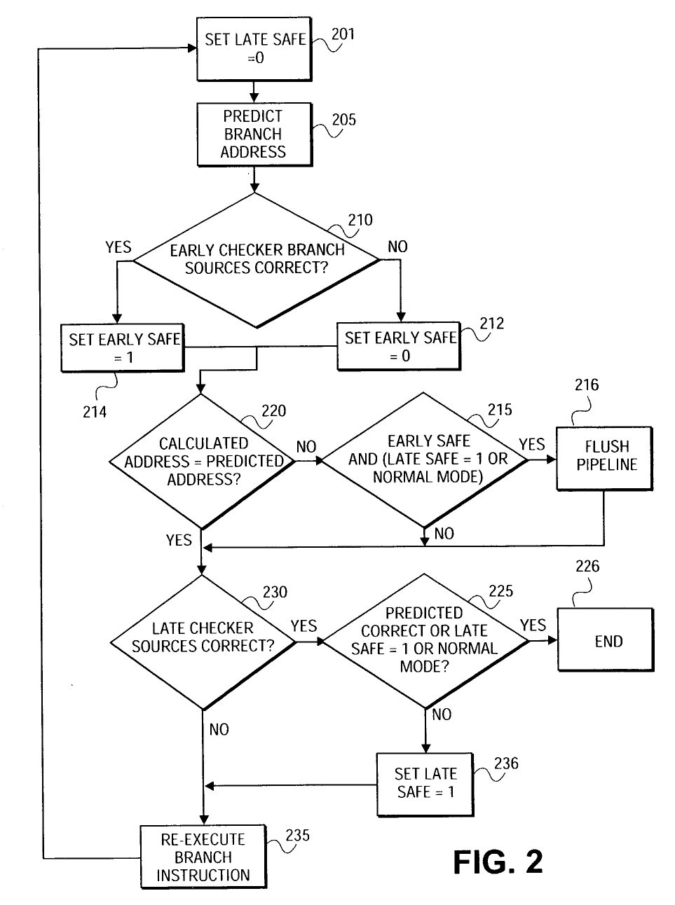

FIG. 2 illustrates a flow diagram of a branch instruction executed in a processor according to one embodiment of the invention. Although the embodiment of FIG. 2 illustrates the processing of a branch instruction other instructions (e.g., traps, loads, arithmetic operations etc.) may also be processed.

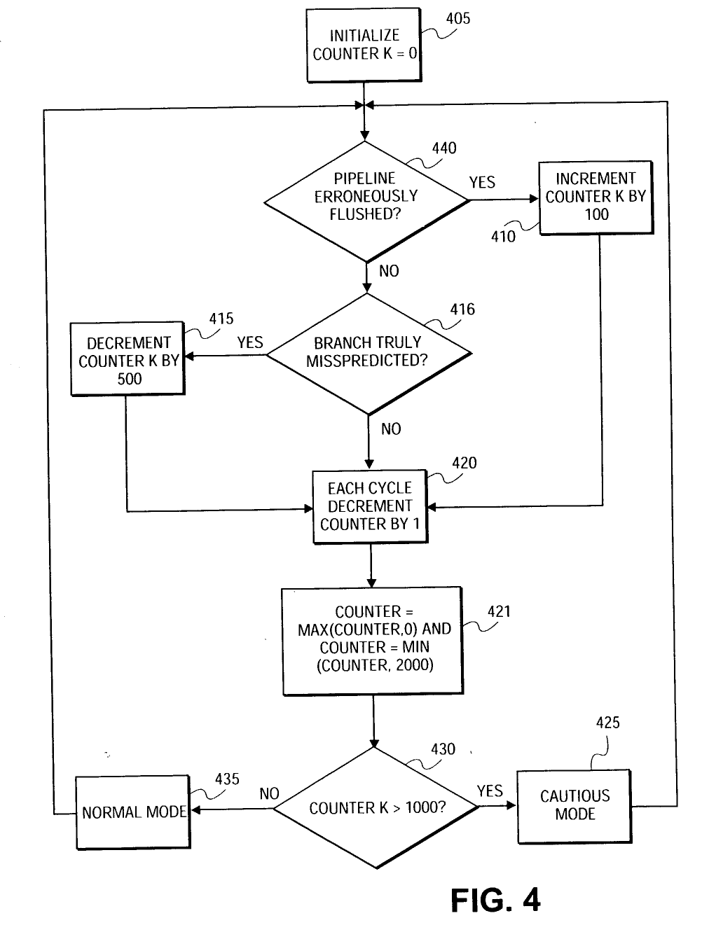

In one embodiment, an out-of-order processor has a controller to monitor the operation of the processor including the number of times the instruction pipeline is erroneously flushed. The controller switches the mode of operation of the processor from the normal mode of operation to a cautious mode of operation if a significant number of erroneous re-executions of instructions occur or a significant number of erroneous pipeline flushes are observed in the normal mode of operation. Details of when a processor switches modes from a normal mode, wherein the instruction pipeline is erroneously flushed, to a cautious mode, wherein the instruction pipeline is not erroneously flushed, are provided with respect to FIG. 4.

As illustrated in FIG. 2, when in the cautious mode of operation, the instruction pipeline is not erroneously flushed. At 201, a “late safe ” flag is set to 0. At 205 a branch prediction algorithm predicts the address of a branch instruction. After the branch prediction algorithm predicts the address of the branch instruction the scheduler schedules the branch instruction for execution by the execution unit. At 210, an early checker determines whether the sources of the branch instruction are correct. If the early checker determines that the sources are correct an “early safe” flag is set to 1 (e.g., by the early checker or by a controller) at 214. Else, if the early checker determines that the sources are not correct the “early safe” flag is set to 0 at 212. In one embodiment, determining whether the sources are early safe includes determining whether the data needed for the branch instruction to execute is likely to be valid data. For example, if a branch depends on a load instruction, then a subset of the tag bits are checked in the cache. If the subset of the tag bits matches the address of the cache block from the processor, then the load data is declared “early safe”. However, it is possible, based on a comparison of all of the tag bits, that the data as a result of the load instruction is not correct. Thereafter, at 220, the execution unit determines whether the calculated branch address is equal to the predicted branch address, and may set a “branch prediction flag” e.g., to a 1 if the calculated address is equal to the predicted address. If the execution unit determines that the branch instruction is not miss-predicted (i.e., the branch predicted flag is set to a 1), the late checker, at 230, determines whether the sources are correct. In one embodiment of the invention, in response to the late checker determining the validity of the sources a “late safe” flag may by set to a 1 (e.g., by the late checker or by the controller), if the sources are correct. However, if a miss-prediction is detected by the execution unit, a determination is made, at 215, whether the “early safe” flag is set to “1” and whether the “late safe” counter is set to 1 at 236. In addition, a determination is made at 215 whether the early safe flag is set to a 1 and whether the processor is in the normal mode of operation. If either of these conditions is true, the processor's pipeline is flushed at 216.

In particular, if a miss-prediction is detected by the execution unit at 220, and if the early safe flag and late safe counter are set to 1, then regardless of the mode of operation of the processor the instruction pipeline is flushed at 216. In addition, if the execution unit determines a miss-prediction is detected at 220, and if the early safe flag is set to a 1, and if the processor is in the normal mode of operation then the instruction pipeline is flushed at 216.

Thus, the instruction pipeline is flushed in accordance with the following expression: early safe=1 AND (late safe counter=1 or processor in normal mode) [1]. If the outcome of expression [1] is false or if the instruction pipeline is flushed, or if the execution unit at 220 determines the calculated address of the branch is equal to the predicted address of the branch, at 230, the late checker determines whether the sources are correct.

In the cautious mode the instruction pipeline is flushed only after the late checker determines that the sources are not correct at least once since in [1] the pipeline is flushed when the late safe counter is ‘1’.

In the cautious mode, the pipeline is flushed after the late checker determines whether the sources contain valid data because the determination of the late checker is correct whereas the determination of the early checker as to the validity of the sources may or may not be correct.

If, at 230, the late checker determines the sources are correct a decision is made at 225 whether the execution unit predicted the branch correctly, or whether the late safe counter is equal to 1, or whether the program is in the normal mode of operation. If any of the conditions tested in 225 are true, the process ends at 226. Alternately, if any of the conditions tested in 225 are false, the late safe counter is incremented to 1 at 236, and the branch instruction is re-executed at 235. Therefore, as illustrated in the flow diagram of FIG. 2, in the cautious mode of operation the instruction pipeline is flushed only when the processor actually miss-predicts a branch instruction.

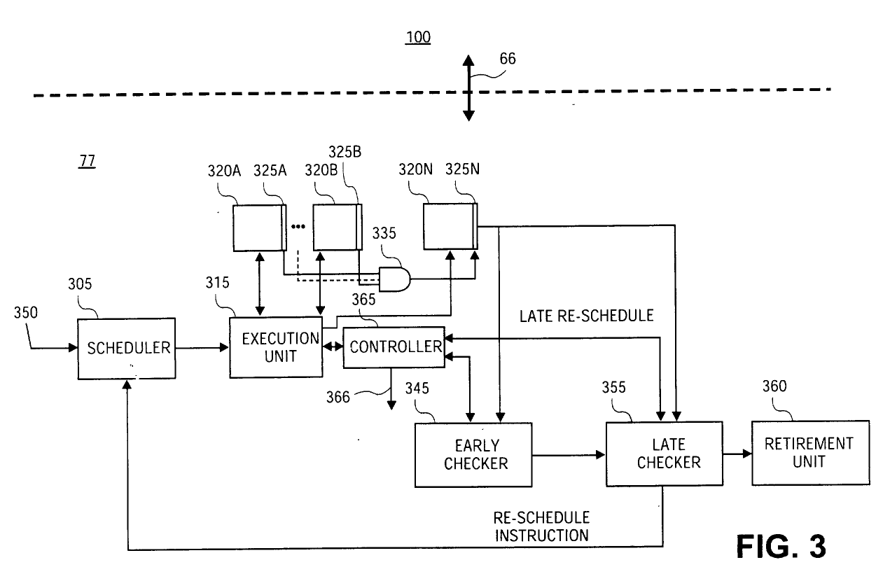

FIG. 3 illustrates a block diagram of a processor according to one embodiment of the invention. As illustrated in FIG. 3, computer system 100 comprises a processor 77 that is coupled to various components of computer system 100, e.g., a memory unit (not shown) via a system bus 66. The memory unit may include random access memory, read only memory or some other permanent or temporary storage device. In one embodiment, processor 77 is an out-or-order processor.

Processor 77 includes a scheduler 305 that receives instructions (e.g., from an instruction pipeline) via bus 350. The instructions received by processor 77 are micro-operations (i.e., instructions generated by transforming complex instructions into fixed length instructions). Each micro-operation or instruction has one or more sources (from which data is read) and at least one destination (to which data is written). In one embodiment of the invention, the source or the destination may be one or more registers within processor 77, cache memory, or even permanent and/or temporary memory (e.g., random access memory RAM).

Scheduler 305 is coupled to an execution unit 315. In one embodiment, scheduler 305 sends instructions from either the instruction queue or instructions from late checker 355 to execution unit 315 for execution. Execution unit 315 executes instructions received from scheduler 305. Execution unit 315 may be a floating-point arithmetic logic unit (ALU), a branch execution unit, a load executing unit (i.e., an executing unit that computes the address location of data, and loads the data from the computed address location), etc.

Executing unit 315 is coupled to one or more registers 320A, 320B, . . . 320N. Although, in the embodiment of FIG. 3, only three registers (i.e., 320A, 320B, and 320N) are illustrated, other embodiments may have more than three registers as illustrated by the dashed line in between registers 320A and 320B in FIG. 3. In one embodiment, the registers are general-purpose registers and data may be read from and written to each of the registers. In one embodiment, each register has an extra bit (called the validity bit) stored in register locations 325A-N in corresponding registers 320A-N that determines the validity of the data in each register. Thus, each register may have an additional bit (i.e., a validity bit) that is contiguous with the data bits in the register. In some embodiments every register has a validity bit to determine the validity of the data in the register, (e.g., validity of the sources for a branch instruction) in alternate embodiments, some registers may have a validity bit, and other registers may not. In one embodiment of the invention, the validity bit is not contiguous with the data bits in the registers but is maintained separate from the register (e.g., in a table). However, a one to one correspondence is maintained between the data in each register and the validity bit. In one embodiment of the invention, if the data in a particular register is valid data, then the validity bit may be set to a logic ‘1’, else the validity bit it is set to a logic ‘0’. In one embodiment of the invention the validity bit is used in lieu of the early safe flag described with referenced to FIG. 2.

In one embodiment of the invention, the validity bit may be set to a logic ‘1’ if a cache ‘hit’ occurs, else if a cache ‘miss’ occurs the validity bit is set to a logic ‘0’. A cache miss occurs, for example, if the address tag of the cache block that contains the desired information does not match the block address from the processor. In one embodiment of the invention, setting a validity bit to a 1 corresponds with setting an early safe flag to a 1. Thus, in one embodiment, the early checker 345, or both the early checker and the late checker 355 may inspect the validity bit associated with the sources (i.e., the source register(s)) to determine whether the sources are correct. Therefore, in one embodiment of the invention, the early and late checkers are coupled to register 320N and in particular to location 325N in the register that stores the validity bit for the sources.

In one embodiment of the invention, a data validity circuit 335 (e.g., an AND gate) is coupled to the registers in processor 77. The data validity circuit determines the validity of the data in the source, e.g., in source registers and indicates the validity of the data in a destination (e.g., a destination register) as follows: If any source register has invalid data (e.g., the validity bit is a logic ‘0’) then the output of the data validity circuit is logic ‘0’, i.e., the data validity circuit 335 sets the validity bit of the destination (e.g., a destination register) to a logic ‘0’. Thus, if a branch instruction is dependent on the data from a previous instruction, the early checker and the late checker may inspect the validity bit of the data from the previous instruction (i.e., the validity bit associated with the destination register) to determine whether the checker sources are correct.

In one embodiment, a controller 365 is coupled to the output of the execution unit 315 and to early and checkers 345 and 355 respectively. In one embodiment of the invention, the output from early checker 345 may be coupled to the input of late checker 355. Controller 365 has a control line 366 that sends a signal to flush the processor's instruction pipeline. In one embodiment of the invention, an output from the late checker is coupled to retirement unit 360, and a second output from late checker is coupled to scheduler 305. Thus, a signal may be sent by the late checker 355 to the scheduler to re-schedule an instruction for execution, or an instruction that has executed correctly by the execution unit may be retired to the retirement unit.

In one embodiment of the invention, signals that determine the condition of the sources are sent by early checker 345 and the late checker 355 to controller 365. In addition, the execution unit may send the branch prediction flag to the controller. In another embodiment of the inventions, the early checker 345, the late checker 355, and the execution unit may send signals that determine the condition of the sources and the result of the branch prediction to scheduler 365. In one embodiment of the invention the controller 365 determines the mode of operation and operates processor 77 in either the normal mode or the cautious mode as illustrated in the flow diagrams of FIGS. 2 and 4. In one embodiment of the invention the scheduler 305 may determine the mode of operation of processor 77 and may signal controller 365 to switch the mode of operation from a normal mode to the cautious mode or vice versa.

As illustrated in FIG. 3, a retirement unit 360 is coupled to the late checker 355. The retirement unit 360 receives instructions from the late checker 355 that have properly executed by execution unit 315. Retiring instructions frees up processor resources and permits additional instructions to execute.

FIG. 4 illustrates a flow diagram illustrating when a processor switches modes according to one embodiment of the invention. As illustrated in FIG. 4, in order to switch modes from the normal mode to the cautious mode and vice versa, the controller 365 may monitor the early safe flag, the late safe counter and the branch prediction flag. At 405, a counter K is initialized to 0. At 440, a determination is made whether the instruction pipeline is erroneously flushed. For example, when the branch is retired, if the branch was predicted correctly but caused the instruction pipeline to be erroneously flushed. If the instruction pipeline is erroneously flushed, at 410, the counter K is incremented by 100. Otherwise, at 416, a determination is made whether the branch was truly mispredicted. For example, when the branch is retired a determination whether the branch was truly miss-predicted is made by examining at least late safe counter. If the branch was truly mispredicted, at 415, the counter K is decremented by 500. At 420, for each processor cycle of operation the counter K is decremented by 1. At 421, the counter saturates so that the counter value does not exceed, e.g., 2000 and the minimum value does not fall less than 0. At 430, a determination is made whether the value K is greater than 1000. If the value of the counter K is greater than 1000, then the processor is operated in the cautious mode at 425, else the processor operates in the normal mode as indicated by 435. In one embodiment of the invention, controller 365 inspects counter K and dynamically switches the mode from the normal mode to the cautious mode and vice versa in accordance with the flow diagram illustrated in FIG. 4. For example when the counter K is above 1000 then the processor operates in the cautious mode and if counter K falls below 1000 then the processor operates in the normal mode of operation. Thus, for each cycle the counter K is monitored e.g., by the controller, and the processor's operating mode is switched depending on the value of K.

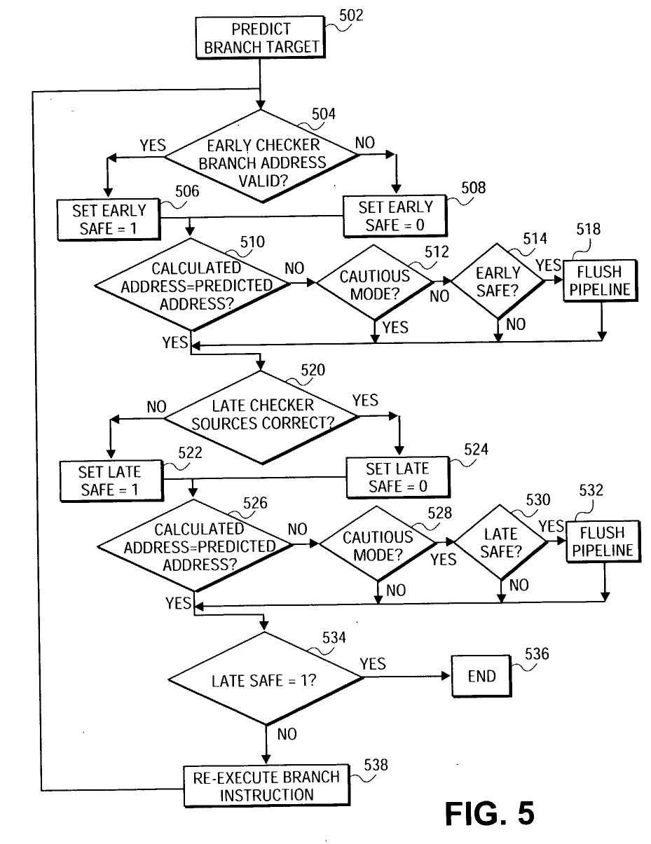

FIG. 5 illustrates a flow diagram of a branch instruction execution in a processor according to another embodiment of the invention. As illustrated in FIG. 5, in the cautious mode of operation, the instruction pipeline is flushed when the processor actually miss-predicts a branch instruction, thereby eliminating the erroneous flushing of the instruction pipeline. At 502 a branch prediction algorithm predicts the address of a branch instruction. After the branch prediction algorithm predicts the address of the branch instruction the branch instruction is scheduled by, e.g., a scheduler for execution by the execution unit. At 504, an early checker, for example, determines whether the sources of the branch instruction are correct. If the early checker determines that the sources are correct an “early safe” flag is set to 1 (e.g., by the early checker, a scheduler or by a controller) at 506. Else, if the early checker determines that the sources are not correct the “early safe” flag is set to 0 at 508. In one embodiment, determining whether the sources are “early safe” includes determining whether the data needed for the branch instruction to execute is valid data.

At 510 the execution unit determines whether the calculated branch address is equal to the predicted branch address. If at 510 the execution unit determines that the branch instruction is not miss-predicted, the late checker, at 520, determines whether the sources are correct. However, if the execution unit detects a miss-prediction at 510, a determination is made whether the processor is in the normal mode of operation at 512. If the processor is in the normal mode at 514 a determination is made whether the “early safe” flag is set to “1”. If the early safe flag is set to a 1 and the processor is in the normal mode, at 518 the processor's instruction pipeline is flushed.

However, if at 510 the execution unit determines that the calculated branch address is equal to the predicted branch address, or if at 512 the processor is operating in the cautious mode of operation, or if at 514 the early safe flag is not set, or if at 518 the instruction pipeline is flushed, then at 520 the late checker determines whether the sources are correct. If at 520 the late checker determines that the sources are correct, at 522 a late safe flag is set to a 1, otherwise, at 524 the late safe flag is set to a 0.

After setting the late safe flag, a determination is made at 526, whether the calculated branch address is equal to the predicted branch address. If the calculated branch address is not equal to the predicted branch address a determination is made at 528 whether the processor is operating in the cautious mode. If the processor is operating in the cautious mode and if at 530 the late safe flag is set, then at 532 the instruction pipeline is flushed.

However, if at 526 the calculated address is equal to the predicted address, or if the processor is not operating in the cautious mode at 528 or if the late safe flag is not set at 530 or if the processor's instruction pipeline is flushed at 532, at 534 a determination is made at 534 whether the late safe flag is set to a 1. If the late safe flag is set to a 1 the process ends at 536. Otherwise, at 538 the branch instruction is re-executed.

This means that in the cautious mode the instruction pipeline is flushed after the execution unit determines that the calculated branch address is not equal to the predicted branch address and the late checker determines that the sources are correct.

Embodiments of the invention may be represented as a software product stored on a machine-accessible medium (also referred to as a computer-accessible medium or a processor-accessible medium). The machine-accessible medium may be any type of magnetic, optical, or electrical storage medium including a diskette, CD-ROM, memory device (volatile or non-volatile), or similar storage mechanism. The machine-accessible medium may contain various sets of instructions, code sequences, configuration information, or other data to execute the method illustrated in the flow diagrams of FIGS. 2, 4 and 5.

Thus, a method and apparatus have been disclosed for executing instructions in a processor. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method for processing an instruction by a processor comprising:
determining the mode of operation of the processor;
determining whether one or more sources an instruction depends upon is valid; and
flushing an instruction pipeline of the processor depending on the mode of operation of the processor.

2. The method of claim 1 wherein determining the mode of operation of the processor comprises determining whether the processor operates in any one of a normal mode of operation and a cautious mode of operation.

3. The method of claim 2 wherein operating the processor in the normal mode of operation comprises:
determining, by an early checker, whether the one or more sources the instruction depends upon is valid;
determining whether the instruction executed correctly by an execution unit comparing a calculated address of the instruction with a predicted address of the instruction; and
flushing the processor's pipeline when an execution unit determines the calculated address does not equal the predicted address of the instruction and the early checker determines that the one or more sources are correct.

4. The method of claim 2 wherein operating the processor in the cautious mode of operation comprises:
determining, by an early checker, whether the one or more sources the instruction depends upon are valid;
determining whether the instruction executed correctly by an execution unit comparing a calculated address of the instruction with a predicted address of the instruction;
determining, by a late checker, whether the one or more sources the instruction depends upon are valid; and
flushing the processor's pipeline when the late checker determines that the one or more sources are invalid and the execution unit determines that the calculated address of the instruction is not equal to the predicted address of the instruction.

5. The method of claim 3 further comprising scheduling the instruction for re-execution when the late checker determines that the one or more sources are invalid.

6. The method of claim 4 further comprising scheduling the instruction for re-execution when the late checker determines that the one or more sources are invalid.

7. The method of claim 1 wherein the processor is an out-of-order processor.

8. The method of claim 2 wherein operating the processor in the cautious mode of operation comprises:
determining, by an early checker, whether the one or more sources the instruction depends upon are valid;
determining whether the instruction executed correctly by an execution unit comparing a calculated address of the instruction with a predicted address of the instruction;
determining, by a late checker, whether the one or more sources the instruction depends upon are valid;
determining whether the instruction executed correctly by an execution unit comparing a calculated address of the instruction with a predicted address of the instruction a second time; and
flushing the processor's pipeline when the late checker determines that the one or more sources are valid, and the execution unit determines that the calculated address of the instruction is not equal to the predicted address of the instruction the second time.

9. The method of claim 8 further comprising scheduling the instruction for re-execution when the execution unit determines that the calculated address of the instruction is equal to the predicted value of the instruction a second time, and the late checker determines that the one or more sources are invalid.

10. A computer system comprising:
a bus;
a memory unit coupled to said bus;
a processor to execute an instruction, said processor, comprising
an early checker to inspect one or more sources;
a late checker coupled to the early checker to inspect the one or more sources; and
a controller coupled to the early checker, the late checker, and an execution unit, said controller to operate the processor in a particular operating mode, said operating mode to re-execute an instruction depending on the operating mode of the processor.

11. The computer system of claim 10 wherein the controller determines whether the processor is operating in any one of a normal mode of operation and a cautious mode of operation.

12. The computer system of claim 11 wherein the normal mode of operation comprises the controller to flush an instruction pipeline when the early checker determines the one or more sources the instruction depends upon are valid, and an execution unit determines the calculated address is not equal to the predicted address of the instruction.

13. The computer system of claim 11 wherein the cautious mode of operation comprises the controller to flush an instruction pipeline when the late checker determines that the one or more sources the instruction depends on are valid and the instruction has been re-executed.

14. The computer system of claim 11 wherein the normal mode of operation comprises the controller to schedule an instruction for re-execution when the late checker determines that the one or more sources are invalid.

15. The computer system of claim 11 wherein the cautious mode of operation comprises the controller to schedule an instruction for re-execution when the late checker deter mines that the one or more sources are invalid.

16. The computer system of claim 10 wherein the processor is an out-of-order processor.

17. The computer system of claim 10 wherein the controller is internally disposed in the execution unit.

18. The computer system of claim 11 wherein the cautious mode of operation comprises the controller to flush an instruction pipeline when the late checker determines that the one or more sources are valid, and the execution unit determines that the calculated address of the instruction is not equal to the predicted address of the instruction a second time.

19. The computer system of claim 18 further comprising the controller to schedule the instruction for re-execution when the execution unit determines that the calculated address of the instruction is equal to the predicted value of the instruction a second time, and the late checker determines that the one or more sources are invalid.

20. An article of manufacture comprising:
a machine-accessible medium including instructions that, when executed by a machine, causes the machine to perform operations comprising
determining the mode of operation of the processor;
determining whether one or more sources an instruction depends upon is valid; and
flushing an instruction pipeline of the processor depending on the mode of operation of the processor.

21. The article of manufacture as in claim 20, wherein instructions for determining the mode of operation of the processor comprises further instructions for determining whether the processor is operating in any one of a normal mode of operation and a cautious mode of operation.

22. The article of manufacture as in claim 21, wherein instructions for operating the processor in the normal mode of operation comprises further instructions for
determining, by an early checker, whether the one or more sources the instruction depends upon are valid;
determining whether the instruction executed correctly by an execution unit comparing a calculated address of the instruction with a predicted address of the instruction; and
flushing the processor's pipeline when an execution unit determines the calculated address does not equal the predicted address of the instruction and the early checker determines that the one or more sources are correct.

23. The article of manufacture as in claim 21, wherein instructions for operating the processor in the cautious mode comprises further instructions for
determining, by an early checker, whether the one or more sources the instruction depends upon are valid;
determining whether the instruction executed correctly by an execution unit comparing a calculated address of the instruction with a predicted address of the instruction;
determining, by a late checker, whether the one or more sources the instruction depends upon are valid; and
flushing the processor's pipeline when the late checker determines that the one or more sources are invalid and the execution unit determines that the calculated address of the instruction is not equal to the predicted address of the instruction.

24. The article of manufacture as in claim 21, wherein instructions for operating the processor in the normal mode of operation comprises further instructions for scheduling the instruction for re-execution when the late checker determines that the one or more sources are invalid.

25. The article of manufacture as in claim 21 wherein instructions for operating the processor in the cautious mode of operation comprises further instructions for scheduling the instruction for re-execution when the late checker determines that the one or more sources are invalid.

26. A processor comprising:
an early checker to inspect one or more sources;
a late checker coupled to the early checker, to inspect the one or more sources; and
a controller coupled to the early checker, the late checker, and an execution unit, said controller to operate the processor in a particular operating mode, to dynamically switch modes, and to re-execute an instruction depending on the mode of operation of the processor.

27. The processor of claim 26 further comprising a scheduler coupled to the execution unit, and an instruction pipeline to schedule instructions to be executed by the execution unit.

28. The processor of claim 26 wherein the controller determines whether the processor is operating in any one of a normal mode of operation and a cautious mode of operation.

29. The processor of claim 28 wherein the normal mode of operation comprises the controller to flush an instruction pipeline when the early checker determines the one or more sources the instruction depends upon are valid, and an execution unit determines the calculated address is not equal to the predicted address of the instruction.

30. The processor of claim 28 wherein the cautious mode of operation comprises the controller to flush an instruction pipeline when the late checker determines that the one or more sources the instruction depends on are valid and the instruction has been re-executed.

31. The processor of claim 28 wherein the normal mode of operation comprises the controller to re-schedule an instruction for re-execution when the late checker determines that the one or more sources are invalid.

32. The processor of claim 28 wherein the cautious mode of operation comprises the controller to re-schedule an instruction for execution when the late checker determines that the one or more sources are invalid.

33. The processor of claim 28 wherein the processor is an out-of-order processor.

34. The processor of claim 28 wherein the controller is internally disposed in the execution unit.

35. The processor of claim 28 wherein the cautious mode of operation comprises the controller to flush an instruction pipeline when the late checker determines that the one or more sources are valid, and the execution unit determines that the calculated address of the instruction is not equal to the predicted address of the instruction a second time.

36. The processor of claim 28 further comprising the controller to schedule the instruction for re-execution when the execution unit determines that the calculated address of the instruction is equal to the predicted value of the instruction a second time, and the late checker determines that the one or more sources are invalid.
